(19) United States
(12) Patent Application Publication
(10) Pub. No.: US 2012/0330930 A1
(43) Pub. Date: Dec. 27, 2012

(54) System for multiple database correlation of location based information

(76) Inventor: Richard Gorgens, Plantation, FL (US)

(21) Appl. No.: 13/507,309

(22) Filed: Jun. 20, 2012

Related U.S. Application Data
(60) Provisional application No. 61/500,645, filed on Jun. 24, 2011.

(51) Int. Cl. G06F 17/30; G06F 15/16

(52) U.S. Cl. 707/722; 707/E17.014

(57) ABSTRACT

A method includes loading an application on a user device wherein the application is configured to receive information requests and to launch search requests utilizing a web mapping service with a local search feature. After launching a search request via the application, the user device receives search results from the web mapping service. At the application, the results are analyzed to ascertain if a search result corresponds to an information request. Such data is added, when not already present, to the database.

### RELATED APPLICATIONS

This application hereby claims the benefit of and priority to U.S. Provisional Application Ser. No. 61/500,645, filed on Jun. 24, 2011 under 35 U.S.C. §§119, 120, 363, 365, and 37 C.F.R. §1.55 and §1.78, and is incorporated herein by this reference.

### FIELD OF THE INVENTION

The subject invention relates to the internet, web mapping services, and database correlation.

### BACKGROUND OF THE INVENTION

Location search marketing and web mapping with a local search feature (such as “Google maps,” “Bing Local,” and “Yahoo Local”) allow a business, for a price, to have information concerning the business appear as a result when a consumer conducts a search. In one example, a user searches for “coffee,” and, the user's location is determined (using GPS, WiFi or cell tower data) and various coffee shops at or near the user's location are returned as results along with a map depicting the location of each coffee shop.

Each business has to make a listing including its address, GPS coordinates, telephone number, website address, and the like and the business can select categories, ad words, and the like.

Various smart phone software applications or “apps” also offer promotions, coupons, and the like on behalf of its customers and clients based, at least in part, on the customer or client's location. See U.S. Pat. No. 7,848,765 incorporated herein by this reference. In the case of a geo-based web service which has customers presented or featured in one way or another to users, the required data entry and overhead can be extensive. Consider a web service which provides coupons, offers, and the like to users based on location on behalf of a customer which has numerous locations, franchisees, or stores. Entering the data for each customer location into a database can be a time consuming, laborious process. A potential customer could decide to not become a customer of the web service if the data entry requirements are oppressive.

### SUMMARY OF THE INVENTION

One aspect of the invention is that if the information already exists concerning a subject, there is no reason the same information should be entered manually into a database used by a server to offer a web service. A web service includes some information concerning a customer in a database, but, at least initially, not all the information useful by the service concerning all the customer sites or locations. Consider a customer that is a popular donut and coffee chain called “Dollars to Coffee and Donuts” with thousands of locations.

An app is downloaded by users on their smart phones. The app learns from the web service that information has been requested for the customer “Dollars to Coffee and Donuts”.

A user then actuates the app at some point at a location near a customer location and desires information concerning coffee. The app launches a search using a web mapping service with a local search feature. The search results returned to the user include the local “Dollars to Coffee and Donuts” franchisee. Knowing that information concerning this customer is desired by the web server, the app extracts data (location or physical address, phone number, website address, and the like) concerning the franchisee and forwards that data to a server which then adds the data to a database.

The next time that user (or any user) activates the app at or near the same location and searches for coffee or donuts, the server, by accessing the database, is now able to provide the user with information concerning the franchisee (physical address, phone number, website address and the like) as well as customer desired coupons, offers, promotions, and the like even at the local level.

In one utility of this technology, customer representatives, for example franchisee managers, can be instructed to download the app and search for their own businesses. The app on each of the manager's devices then operates to provide the necessary data to the server and database, as described above, so that effectively, data concerning thousands of customer locations can be loaded into the database via the push of a single button by each store manager.

Featured is a method of populating a database. One preferred method comprises loading an application on a user device. This application is configured to receive information requests (be on look out or “bolo”) be on look out, and to launch search requests utilizing a web mapping service with a local search feature. A search request is made via the application location and search results from the web mapping service are returned. The search results are analyzed to ascertain if any search result corresponds to an information request. If so, data concerning the search results from the app are forwarded to a server configured to populate a database. There, the search results are analyzed to determine if data concerning the results is missing from database and data is added to the database when required.

In some examples, the method further includes forwarding the search request to the server and returning search results from the server to the application based on the location of the user device. Upon launching a search request via the application, it is typically updated with new information requests.

An application in accordance with examples of the invention includes searchable categories, an interface receiving information requests, and storage means for the received information requests. Programming is configured to launch searches utilizing a web mapping service with a local search feature and to display search results returned by the web mapping service. An analyzer is configured to ascertain if a search result returned corresponds to an information request. A communications module is configured to forward search results to a server which populates a database with search results corresponding to information requests. The application may be further configured to forward location data and each search request launched by the app to the server and to display search results received from the server.

A method of populating a database with customer data includes registering a customer via a server, downloading to customer representatives an application configured to receive customer information requests and to launch search requests utilizing a web mapping service with a local search feature, and serving a customer information request to the applications. At or near a plurality of customer locations, the applications are activated to search for local customer locations using the web mapping service. The method includes returning search results to the applications including local customer data, forwarding to a server the local customer data, and populating a database with the local customer data.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a highly schematic view showing an application loaded on a user device in accordance with an example of the invention;

FIG. 2 is a screen shot showing the app now activated;

FIG. 3 is another screen shot showing the app in use;

FIG. 4 is a block diagram showing the primary components associated with the app discussed with respect to FIGS. 1-3;

FIG. 5 is a flow diagram showing the app receiving information from a VNSQ server in accordance with examples of the invention;

FIG. 6 is a flow chart depicting the primary steps associated with the method depicted in FIG. 5;

FIG. 7 is a schematic block diagram showing the flow of information from the app when a search request is made by a user in accordance with examples of the invention;

FIG. 8 is a flow chart depicting the primary steps associated with the method depicted in FIG. 7;

FIG. 9 is a block diagram showing how the app also sends a request to the VNSQ server in accordance with the invention; and

FIG. 10 is a flow chart depicting the primary steps associated with the method depicted in FIG. 9.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

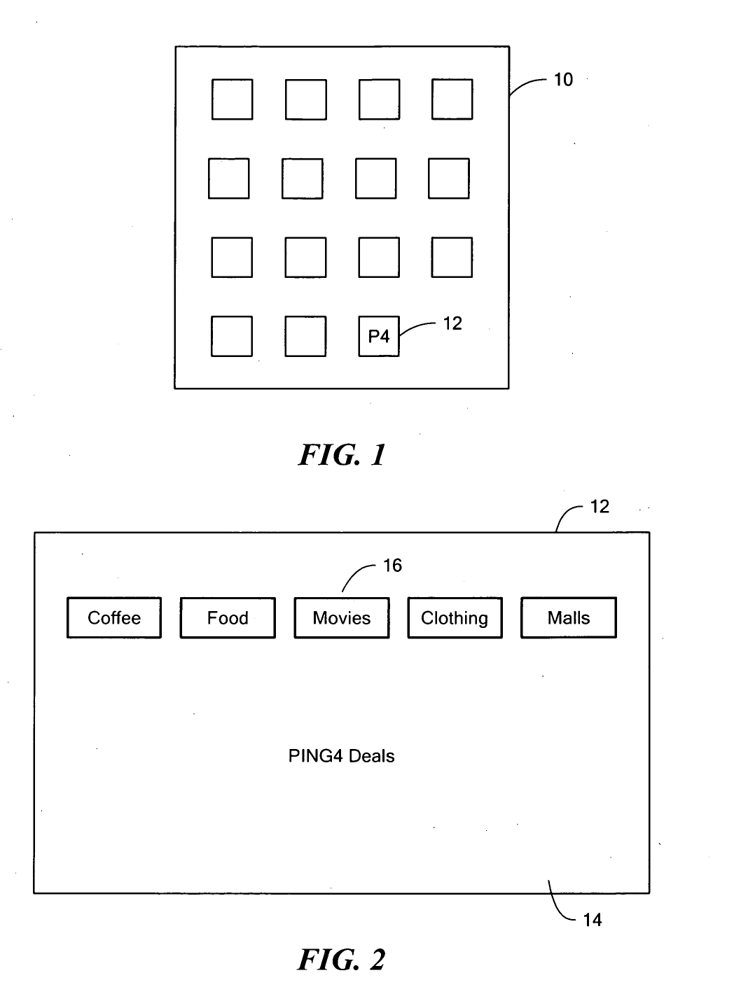

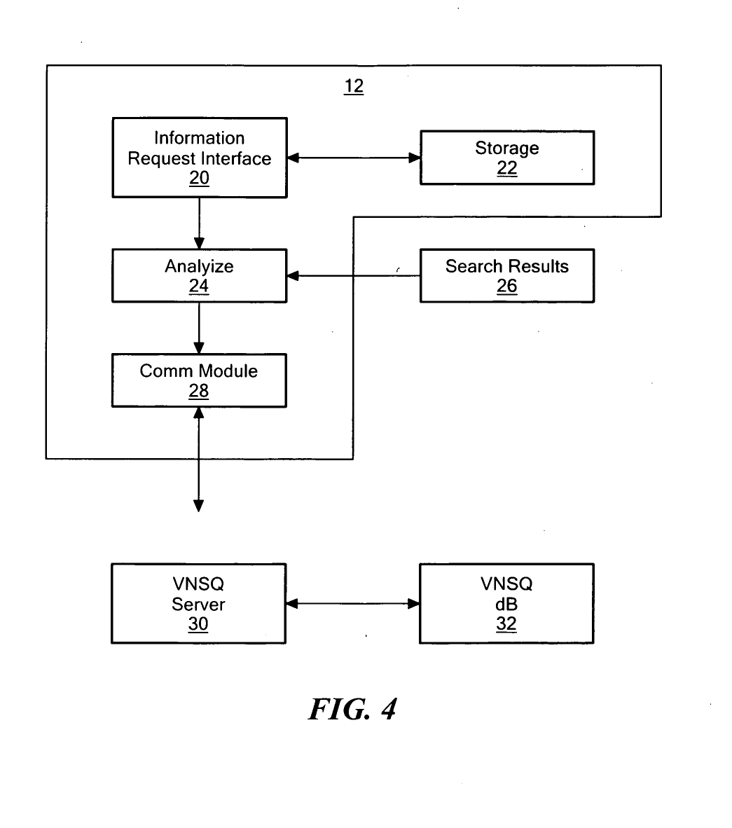

FIG. 1 shows use of mobile device 10 (e.g., a smart phone) loaded with one or more applications including app 12. App 12 on VNSQ server 30, FIG. 4 is downloadable from any smartphone application store or other website. An example of a screen for app 12, when activated, is shown at 14 in FIG. 2. The app is loaded on the user's device using conventional technology. In some embodiments, the app features a type of geo-based web service where coupons, offers, and the like are provided to consumers on behalf of the service's customers. See, for example, the website Ping4.com and U.S. Pat. No. 7,848,765 incorporated herein by this reference.

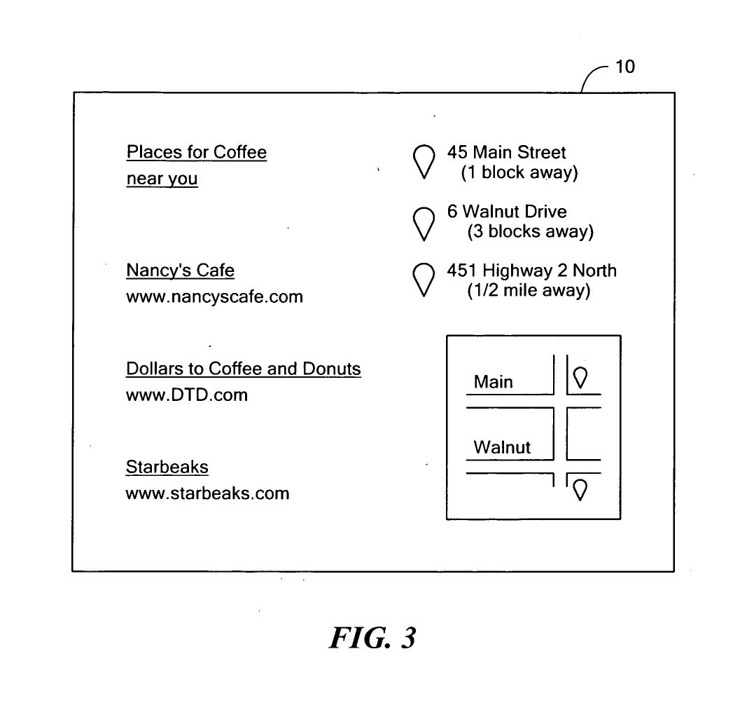

In one example, the corporate “Dollars to Coffee and Donuts” business is a customer of the web service, and under certain conditions, consumers within a block of a “Dollars to Coffee and Donuts” location are provided with a coupon for free coffee by the app. The user may launch search requests via app categories as shown at 16 and the app may be configured to launch one search request to the specialized VNSQ server based on the category selected and also to launch a search utilizing a web mapping service with a local search feature which returns results as shown in the example of FIG. 3 if the category “coffee” is selected.

The primary components of the app include searchable categories as shown in FIG. 2 and means for presenting search results as shown in FIG. 3 as well as an interface 20, FIG. 4 for receiving information requests which are stored as shown at 22. Programming associated with the app launches user requested searches utilizing one or more web mapping services with a local search feature and displays the results as shown in FIG. 3. Analyzer 24, FIG. 4 is configured to ascertain if a search result as shown on the screen in FIG. 3 and at 26 in FIG. 4 corresponds to an information request stored in memory 22. Communications module 28 is configured to forward search results, when they match or correspond to an information request, to VNSQ server 30 which then populates VNSQ database 32 if the search results at 26 are needed data as described below.

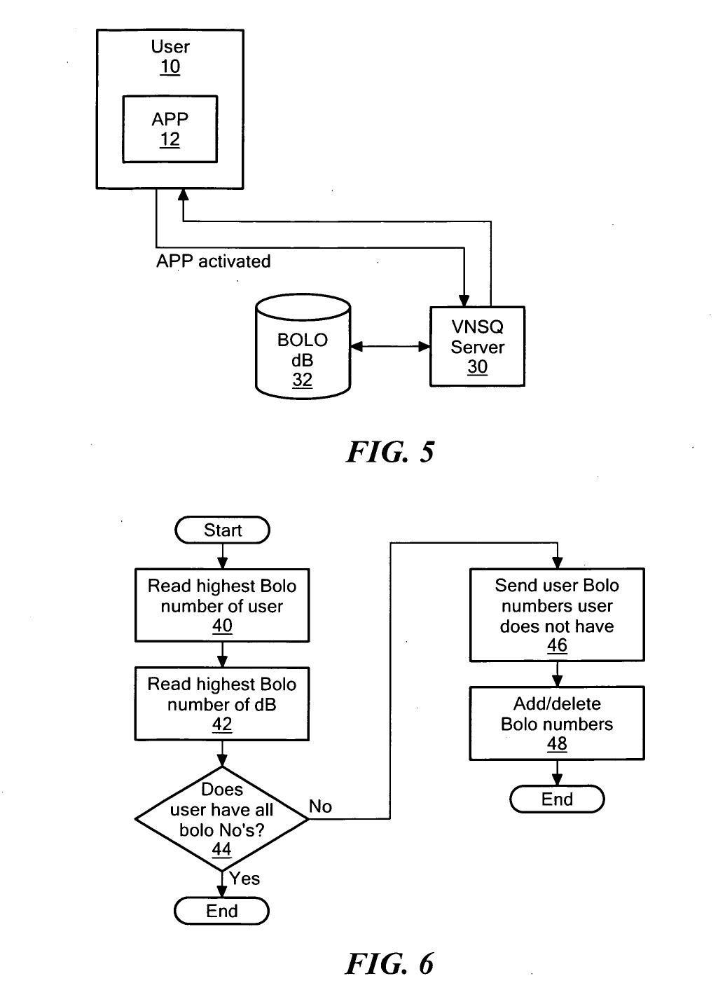

In FIG. 5, user device 10 is loaded with app 12 configured to receive information requests from VNSQ server 30 which interfaces with VNSQ database 32. Each time app 12 is activated, it communicates via the interne with VNSQ server 30 and transmits to VNSQ server 30 the highest “bolo” number the user has stored (in storage 22, FIG. 4), step 40, FIG. 6. VNSQ server 30, FIG. 5 then reads the highest bolo number stored in bolo database 32, step 42, FIG. 6. If the user has all of the bolo numbers, or, in other words, the highest bolo number stored in database 32, this sub-process ends, step 44, FIG. 6. Otherwise, VNSQ server sends the user all the bolo numbers that the user app does not have, step 46, FIG. 6 and also instructions as shown at 48 to add or delete bolo numbers. In one example, a given bolo number could be an instruction to delete a previously stored bolo number.

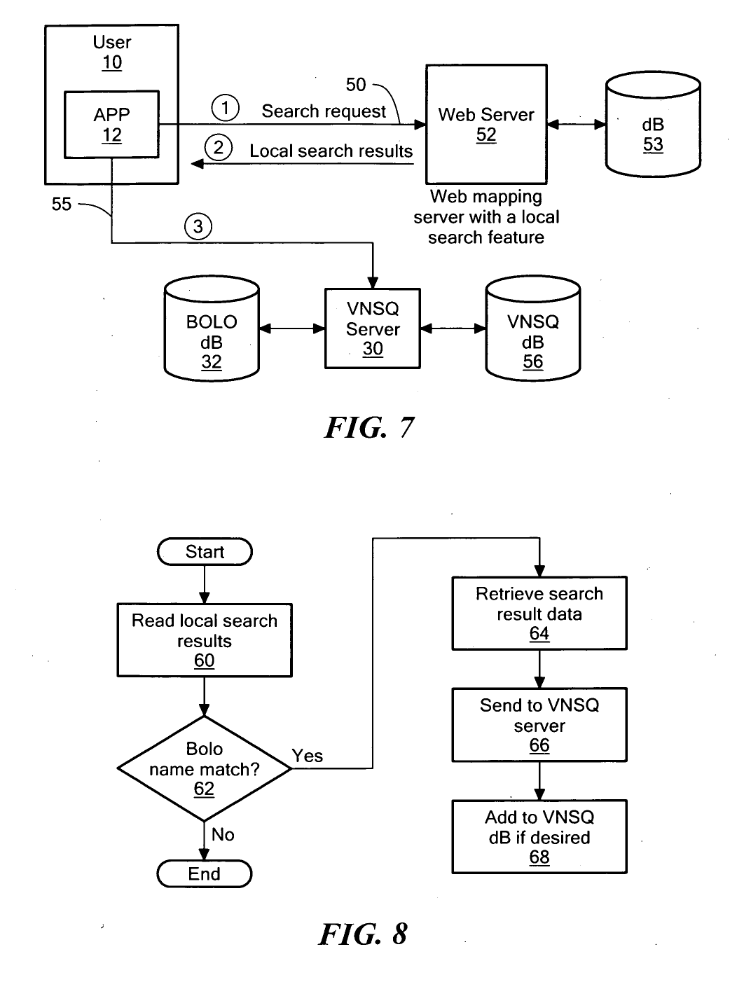

The bolo numbers represent customers, for example, the “Dollars to Coffee and Donuts” customer referred to in the above example. So, for example, if a particular user launches app 12, FIG. 5 and database 32 includes bolo number data representing the fact that “Dollars to Coffee and Donuts” is now a customer of the VNSQ server 30 service, VNSQ server 30 essentially assures that user 10 app 12 is now informed that “Dollars to Coffee and Donuts” is a customer of the service. This feature is included so that, as customers are added over time to VNSQ database 32, FIG. 5, all the user apps are updated accordingly. Thereafter, app 12 is programmed to seek out customer locations, customer data, and the like and to forward such data to VNSQ server 30 in order to populate VNSQ database 56, FIG. 7 with data concerning customer sites, stores and/or locations.

As described above, it may be the case that a particular customer has numerous locations and the specific information concerning each location may not be present in VNSQ database 56. Thus, app 12, FIG. 7 is configured, when activated, and when a user desires a category or other search request, to launch a search as shown at 50 utilizing a web mapping service 52 with a local search feature. See U.S. Pat. Nos. 8,112,308; 6,757,740; 6,487,538; and published Patent Application No. U.S. 2011/0313859.

Returned to the user device 10 are the search results from web mapping service 52 which may interface with database 53. FIG. 3 shows the search results displayed on user device 10 via app 12, FIG. 7. Analyzer code or routine 24, FIG. 4 then analyzes these search results to ascertain if a search result corresponds to an information request as discussed above. In this particular example, as shown in FIG. 3, there is information about a local “Dollars to Coffee and Donuts” store a few blocks away from a user device. The app is programmed to ascertain that “Dollars to Coffee and Donuts” is a customer of the web service and that information concerning local “Dollars for Coffee and Donuts” franchisees is desired. As shown at 55 in FIG. 7, the app forwards all the information concerning this local customer to VNSQ server 30 which analyzes the results to determine if the data concerning the search request result is missing from VNSQ database 56. VNSQ 30 adds data to database 56 when needed.

In one example, the search results from web server 52 includes the telephone number, website address, and physical location of the “Dollars to Coffee and Donuts” location which is now added by app 12 and server 30 to VNSQ database 56 alleviating the need for the “Dollars to Coffee and Donuts” customer to engage in data entry in order to list the telephone numbers, physical addresses, and individual web sites for hundreds if not thousands of individual customer locations.

As shown in FIG. 8, app 12, FIG. 7 is programmed to read the local search results, step 60 and determine, via the analyzing component of the code, whether there is a bolo name match at step 62. If there is a bolo name match, search result data is retrieved at step 64 and sent to the VNSQ server 66, FIG. 7 which populates the VNSQ database at step 68, FIG. 8 as desired.

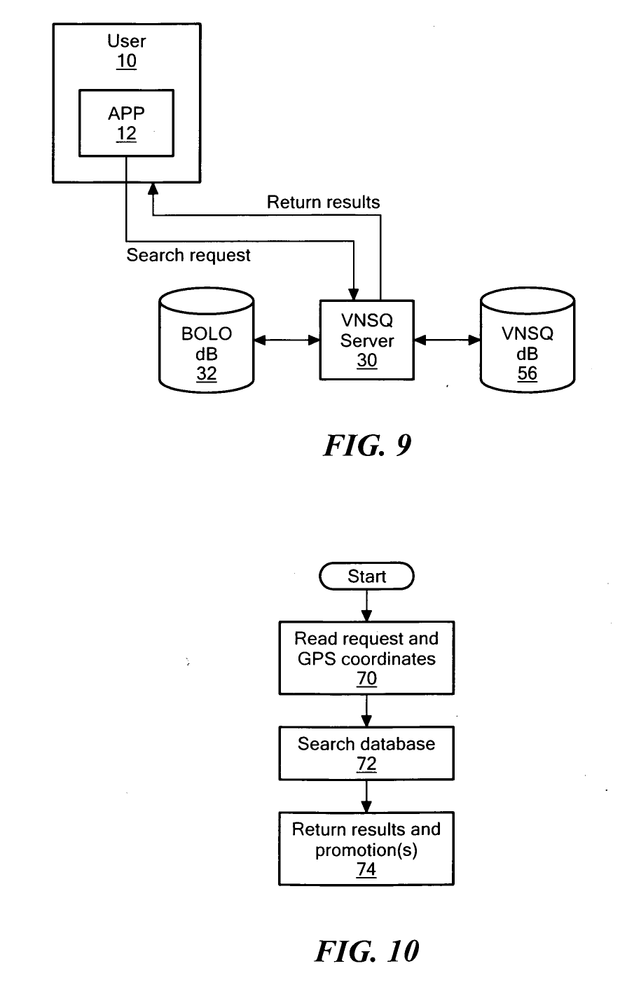

Now with VNSQ database 56, FIG. 9 populated with a larger number of individual locations as more and more users launch the aforementioned app, when the app is used and a search request is made, VNSQ server 30, FIG. 9 is able to return not only results based on data in VNSQ database 56 but also promotions, offers, coupons, and the like. In step 70 of FIG. 10 the user's search request is read by VNSQ server 30 and the users GPS or cell phone triangulation coordinates are noted, step 70. Database 56, FIG. 9 is then searched, step 72, FIG. 10 and results and promotions are returned to the user at step 74. Typically, wherever the app is activated and a search request is made by the user, the app interfaces with both VNSQ server 30, FIG. 9 and one or more web servers 52.

A web service offered by VNSQ server 30, FIGS. 7-10 includes some information concerning a customer in database 56, but at least initially, not all the information useful by the service concerning all the customer sites or locations. Consider a customer with thousands of locations.

App 12 is downloaded by users on their smart phones. The app learns from the web service, that information has been requested for the customer. The user then actuates the app at some point in a location near a customer location and desires information concerning coffee. App 12 launches a search using a web mapping server 52 with a local search feature. The search results returned to the user include the local franchisee. Knowing that information concerning this customer is desired by web server, 30 app 12 extracts data (location, phone number, website address, and the like) concerning the franchisee and forwards the data to a server 30 which then adds the data to database 56.

The next time that user (or any user) activates the app at or near the same location, the server is now able to provide to the user information concerning the franchisee as well as customer desired coupons, offers, promotions, and the like even at the local level.

In one example, customer representatives, for example franchisee managers, can be instructed to download 12 app and search for their own business. The app on each of the manager's devices then operates to provide the necessary data to the VNSQ server as described above so that effectively, data concerning thousands of customer locations is loaded into database 56 via the combination of pushes of a single button of each manager.

The preferred app obtains merchant site data from two separate sources. GMQ (“Google Map Query” or other similar services,) that provides 10-30 sites in multiple or singular categories based on GPS position received from the phone and VNSQ (Virtual Network Server Query) of paid or related sites with deals or not. These may be registered into the database 32, FIG. 4. Sites in the database are searchable either by IP or GPS coordinates.

The results received are combined (merged and sorted by distance) to form merchant site lists presented to the customer.

In background operation, when the user device is sleeping, the user device only performs a VNSQ query and that call responds with sites in all categories that are within the user specified GPS deal radius.

A flag in each record indicates if it is a paid deal site or not. If it is a paid site, the background network will make an http: call to the website contained within the VNSQ data structure by adding a # to the end of the URL and the promotion center will respond with any current deals in text form.

For example, http://pc101.P4Server.com/$dd might be the link for a “Dollars to Coffee and Donuts” site. Calling this link will return the complete graphical ad with the embedded

Ads and Footers, http://pc101.P4Server.com/$dd# might return “Dollars to Coffee and Donuts”—10 free donuts to any child under 10 accompanied by an adult. No purchase necessary. Promo code DD408.

It is the # text version of the request that is spoken with Text-To-Speech (TTS), playing a recorded file, or displayed in a message box on the user's phone.

Considering the tens-of-millions of merchants in the GMQ database as opposed to the number of sites in the evolving VNSQ database, one way to help evolve and populate the VNSQ database is needed without manually inputting all the customer sites especially major store chains each of which might have tens-of-thousands of stores.

BOLO, a (Be On Look Out) database on the VNSQ and iPhone plus others, a client that is auto-synchronizing. This database on the VNSQ includes a unique sequentially assigned number (B-num) when a BOLO is added, along with an up to “n” character Name for the account, and a record number for the master account (MA-num) of the BOLO in the VNSQ database for site lookup. Each VNSQ request from the client includes a (B-num) of the last B-Num in its database +1.

If this B-num exists on the server, it is returned as part of the normal structure of sites in the radius except that the GPS coordinates are set to 0,0 indicating it is a BOLO entry. This entry is saved in the app database indexed to store name, the last recorded BOLO record number is incremented by 1. If no response is received or no entry has GPS 0,0 we assume we are up to date and will request the same B-num on the next VNSQ.

At the client side, the bolo database includes the B-num so we can delete it or modify it if things change, Name (40 characters max.), Website address (normally our promotion center server), paid flag indicating it is a DEAL site, category bit assignments indicating to which category(s) the sites belongs to, MA-num (Master Account Number for the VNS database), and company foreground and background color scheme. The client database is indexed on company name and B-num.

Ping4 Group does a deal with a major retail chain. The Ping4 Group sets up a Master Site for them on a Promotion Center which assigns them a web link for the master promotions, company colors, category bit(s), MA-num is assigned, paid flag or not, and creates the master record on the VNSQ database as well as a local copy on the Master Ping4Deals database including contact info, email and contact phones, salesman, account manager etc. There is also a checkbox to [x] Send BOLO. If set, it also sends the VNS a BOLO add command that allows the VNS database to add the BOLO as the next sequential number and sends that number back to the Ping4Deals database server indicating a completed transaction. The Ping4Deals server updates the master record with the BOLO number (B-num).

When the client does any category search (we know each assigned category bit value and assume a bit value for custom search to be 0), We first compare the sites in the VNSQ responses to the same query and throw out the matching GMQ sites as we already have our own data on the sites and VNSQ has higher priority, the app examines the remaining GMQ (Google Map Query) responses and lookup every site name in the Local smartphone BOLO database. If we have a match on the name, we now know that this is a site that the VNS does not know about. We therefore build a VNSQ record locally with the BOLO database given precedence e.g., B-num, Name, website address (normally our promotion center server), paid flag indication it is a DEAL site, category bit assignments indicating which category(s) the sites belong to, MA-num (Master Account Number for the VNS database), and company foreground and background color scheme, and company LOGO pointer.

The app then adds the following from the GMQ record. Store address, store GPS coordinates, the category bits from five above OR'ed with the category that we searched and retrieved these results, and our client IP if we are on a WiFi connection and the distance to this store's GPS coordinates is 0 miles, otherwise 1.1.1.1 as the IP.

Note that this above step can be implemented in the future to also update the IP's based on 0.0 mi. relative positions if WiFi and 1.1.1.1 is retrieved in the VNSQ record indicating that we don't have a valid WiFi. We can also OR in the HotSpots Category to the Category Bits.

A new record is sent to the VNS server via a data Add/Update http: command and the cycle is complete.

The next person to hit [Show Me the Deals] in range of this newly added store as well as a client on this request will see this chain store listed as a deal site with the deal web links and the company colors.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A method of populating a database, the method comprising:
loading an application on a user device, the application configured to receive information requests and to launch search requests utilizing a web mapping service with a local search feature;
launching a search request via the application;
returning to the user device search results from the web mapping service;
analyzing the search results to ascertain if a search result corresponds to an information request;
forwarding data concerning said search results from the application to a server configured to populate a database;
analyzing the search results to determine if data concerning the results is missing from database; and
adding said data to said database when said data is not present in the database.

2. The method of claim 1 further including forwarding the search request to the server and returning search results from the server to the application based on the location of the user device.

3. The method of claim 1 further including, upon launching a search request via the application, updating the application with information requests.

4. An application comprising:
searchable categories;
an interface receiving information requests;
storage means for the received information requests;
programming configured to launch searches utilizing a web mapping service with a local search feature and to display search results returned by the web mapping service;
an analyzer configured to ascertain if a search result returned corresponds to an information request; and
a communications module configured to forward search results to a server which populates a database with search results corresponding to information requests.

5. The application of claim 4 in which the application is further configured to forward location data and each search request launched by the app to the server.

6. The application of claim 5 in which the application is further configured to display search results received from the server.

7. A method of populating a database with customer data, the method comprising:
registering a customer via a server;
downloading to customer representatives, an application configured to receive customer information requests and to launch search requests utilizing a web mapping service with a local search feature;
serving a customer information request to the applications;
at or near a plurality of customer locations, activating the applications to search for local customer locations using the web mapping service;
returning search results to the applications including local customer data;
forwarding to a server the local customer data; and
populating a database with the local customer data.

8. A method of populating a database with customer data, the method comprising:
registering a customer via a server;
downloading to users, an application configured to receive customer information requests and to launch search requests utilizing a web mapping service with a local search feature;
serving a customer information request to the applications;
at or near a local customer location, activating an application to search for a local customer location using the web mapping service;
returning search results to the application including local customer data;
forwarding to a server the local customer data; and
populating a database with the local customer data.

9. A method of populating a database, the method comprising:
loading an application on a user device, the application configured to receive information requests and to launch search requests utilizing a web mapping service with a local search feature or accessing a VNSQ database;
launching a search request via the application proximate a WiFi location while connected to a WiFi device having an IP address;
returning to the user device search results from the web mapping service or VNSQ database;
analyzing the search results to ascertain if a search result corresponds to an information request;
forwarding data concerning said search results from the application to a server configured to populate a database;
analyzing the search results to determine if data concerning the results is not present or is different in the database;
adding said data to said database when said data is not present or different in the database; and
if the user device is sufficiently proximate the WiFi location, adding or updating the WiFi IP address to the database.
